(19) United States
(12) Patent Application Publication
(10) Pub. No.: US 2023/0115002 A1
(43) Pub. Date: Apr. 13, 2023

(54) PROCESS FOR THE PRODUCTION OF NITRIC ACID

(71) Applicant: CASALE SA, Lugano (CH)

(72) Inventors: Fabio OLDANI, Cantello (IT); Alberto GARBUJO, Como (IT); Pierdomenico BIASI, Como (IT)

(21) Appl. No.: 17/908,654

(22) PCT Filed: Feb. 24, 2021
(86) PCT No.: PCT/EP2021/054603

§ 371 Date: Sep. 1, 2022

(30) Foreign Application Priority Data
Mar. 6, 2020 (EP) 20161496.3

(51) Int. Cl. C01B 21/40; B01J 29/68; B01J 8/04

(52) U.S. Cl. CPC C01B 21/40; B01J 8/0492; B01J 8/0496; B01J 29/68

(57) ABSTRACT

A process for producing nitric acid comprising: catalytic oxidation of ammonia in the presence of oxygen to form a nitrous gas containing NO, O2, N2O and water vapor; a catalytic abatement of N2O which is performed over a first catalyst; a catalytic conversion of NO into NO2 which is performed over a second catalyst; the so obtained nitrous gas is then subject to absorption in water to produce nitric acid.

### DESCRIPTION

### FIELD OF THE INVENTION

The invention relates to a process and plant for nitric acid.

### PRIOR ART

The industrial process for the synthesis of nitric acid involves basically the following steps:
a catalytic oxidation of ammonia, in a suitable ammonia oxidation reactor, producing a gas containing nitrogen oxides NOx (NO and NO2) and nitrous oxide (N2O);
a subsequent step of absorption, in a suitable absorber, wherein nitrogen dioxide (NO2) is absorbed in water to produce nitric acid.

The absorption step produces a liquid product stream containing nitric acid, and a tail gas containing N2O and residual NOx. This tail gas may be work-expanded for energy recovery before being discharged into the atmosphere.

The nitrous gas effluent from the ammonia oxidation reactor is at high temperature. A nitric acid plant normally comprises heat exchange equipment between the ammonia oxidation reactor and the absorber, arranged to recover heat from the hot nitrous gas. This equipment is also termed cooling train and may include a steam superheater, an evaporator, a tail gas heater and an economizer. Accordingly the heat removed from the nitrous gas may be used to produce steam and to preheat the tail gas effluent from the absorber.

N2O and NOx are known pollutants and their presence in the tail gas discharged in the atmosphere is a concern. There are considerable efforts to remove said pollutants from the tail gas or at an earlier stage of the process.

Since N2O does not play a role in the absorption process, it may be removed from the gas after the oxidation of ammonia and before the absorption stage, which is termed secondary abatement. Generally N2O is removed by catalytic decomposition to N2 and O2. However the removal of N2O requires a catalyst which is generally expensive.

The nitrogen oxide NO may also be (at least partially) oxidized to nitrogen dioxide NO2 after oxidation of ammonia and before adsorption, for example in the cooling train between the ammonia oxidation reactor and the absorber. Oxidation of NO to NO2 is desirable because it enhances the absorption step and reduces the residual NOx in the tail gas. The related chemical reaction is NO + ½ O2 ➔ NO2.

The oxidation of NO to NO2 may be performed catalytically or without a catalyst. In both cases it has drawbacks. In case of non-catalytic oxidation to NO2, the drawbacks include the need of large piping and equipment which entails a substantial capital cost and plot area occupation, as well as inefficiency because much of the oxidation heat is lost to cooling water. In case of catalytic NO oxidation to NO2, the main drawback is the very high cost of the catalysts, e.g. based on precious metals.

### SUMMARY OF THE INVENTION

The problem addressed by the invention is how to reduce cost and energy consumption of a nitric acid plant particularly with reference to the processing of the nitrous gas, obtained after oxidation of ammonia, in order to remove N2O and convert NO to NO2.

Accordingly, a first aspect of the invention is a process according to claim 1.

The nitrous gas obtained from catalytic oxidation of ammonia is treated catalytically to remove N2O and to convert NO into NO2.

The term of nitrous gas denotes the gas at various stages of its processing between the ammonia oxidation reactor and the absorber.

The removal of N2O is performed by passing the nitrous gas over a first catalyst. The subsequent conversion of NO to NO2 is performed catalytically, after the removal of N2O, passing the gas over a second catalyst.

The first catalyst and the second catalyst may be the same catalyst or different catalysts.

The first catalyst and/or the second catalyst preferably contain a transition metal-oxide or aluminum silicate. The term of transition metal denotes any element within the period 4, period 5, period 6 of periodic table of elements.

More preferably the first catalyst and/or the second catalyst contain an iron loaded ferrierite (Fe-FER) or a ferrierite which is not loaded with iron (FER). The term ferrierite denotes a structure of a zeolite.

Said FER catalyst is a catalyst obtainable with a process wherein no iron and no transition metal is loaded into the FER zeolite. Particularly, no ion exchange procedure to load iron or any transition metal into the zeolite structure is performed during the manufacturing process of the catalyst.

Fe-FER is particularly preferred having the advantage of more deN2O activity and longer life compared to FER not loaded with iron.

Preferably the removal of N20 is performed at a higher temperature than the oxidation of NO. For example the removal of N2O may be performed around 500° C. or more and the oxidation of NO may be performed at around 300° C. or less. Accordingly the first catalyst may be a high-temperature catalyst and the second catalyst may be a low-temperature catalyst. The gas after removal of N2O may be for example cooled in a waste heat boiler before the oxidation of NO.

An advantage of the invention is that the catalytic oxidation of NO to NO2 allows reaching a higher oxidation ratio compared to the prior art. Additionally, the gas effluent has a higher temperature allowing more heat recovery e.g. as a production of steam.

The preferred transition metal-oxide or aluminum silicate catalyst is robust, inexpensive and not based on scarce materials. Another advantage is that said catalyst can be shaped as structured catalyst. Another advantage is that said catalyst can operate in the preferred temperature range for removing N2O (500° C. or more) without compromising the lifetime, and it can operate in the preferred temperature range for NO to NO2 oxidation.

The concentration of O2 in the gas is higher after the decomposition of N2O, which enhances the oxidation in the downstream NO to NO2 catalytic step and also favors the subsequent absorption of NOx in water in the absorber. Therefore it can be said that the removal of N2O and the oxidation of NO cooperate in a synergetic manner.

The cost of N2O decomposition catalyst and the size of the NO oxidation equipment are significantly reduced, compared to the prior art. The efficiency is increased because the invention, particularly with the use of a high-temperature removal of N2O and low-temperature oxidation of NO, provides an improved heat recovery profile, with a closer approach to the thermodynamic equilibrium of the reaction of oxidation of NO into NO2.

Another aspect of the invention is the finding that a Fe-FER catalyst (FER zeolite loaded with iron) is suitable for the catalytic oxidation of NO to NO2 in a nitric acid process. Accordingly an aspect of the invention is a process for producing nitric acid comprising:
catalytic oxidation of ammonia in the presence of oxygen to form a nitrous gas containing NO, O2, N2O and water vapor;
processing the so obtained nitrous gas and using the so obtained processed nitrous gas to produce nitric acid by absorption of NO2 in water;
characterized in that the processing of nitrous gas comprises a step of oxidation of NO to NO2 which is performed over a Fe-FER catalyst.

Still another aspect of the invention is the finding that an aged Fe-FER catalyst, previously used for decomposition of N2O, can still be used in a nitric acid process for the oxidation of NO to NO2. Accordingly an aspect of the invention is the following: in a process for production of nitric acid, the use of aged Fe-FER catalyst, previously used for decomposition of N2O in a gas containing nitrogen, oxygen, N2O, NOx and water, as a catalyst for oxidation of NO to NO2, to increase the content of NO2 in a nitrous gas before contacting the gas with water for absorption of NO2 in water and production of nitric acid.

For example a Fe-FER catalyst used for the N2O abatement and having lost 10% or more of the initial activity may be considered a spent catalyst for the purpose of decomposition of N2O but can still be used as NO oxidation catalyst.

Said gas containing nitrogen, oxygen, N2O, NOx and water may be for example a nitrous gas or a tail gas of the same or another nitric acid production process.

### Preferred Embodiments

The first catalyst and/or the second catalyst may include or may be constituted by an iron loaded ferrierite (Fe-FER) or ferrierite which is not loaded with iron (FER).

In a particularly preferred embodiment both the first catalyst and the second catalyst contain iron-loaded ferrierite (Fe-FER) and the first catalyst has a higher concentration of iron than the second catalyst.

The considerably high stability of the FER zeolite allows using a spent Fe-FER as catalyst for NO oxidation, giving a second life to the catalyst.

Fe-FER catalyst is preferably used for the reduction of N2O concentration in cooling train to a proper level. The activity of the catalyst for the N2O decomposition is expected to decrease during the time. As the N2O level at the outlet does not meet the process requirements, the used catalyst is deemed a spent catalyst and has to be replaced with new Fe-FER catalyst (fresh catalyst).

Nevertheless, according to the invention, the spent Fe-FER catalyst maintains the activity for NO oxidation to NO2 at low temperature, so that said spent Fe-FER catalyst can be used as NO oxidation catalyst, after being used formerly as N2O abatement catalyst, saving the cost of the replacement. For example a Fe-FER catalyst used for the N2O abatement that lose more than 10% of the initial activity, called spent catalyst, can be used as NO oxidation catalyst. Fresh and spent catalysts operate as N2O abatement at the same process conditions including temperature, pressure and space velocity and N2O content at the inlet of the catalyst bed. The term fresh catalyst typically denotes a catalyst which is installed since less than 1 year.

The catalytic abatement of N2O is performed preferably at 400° C. to 700° C., more preferably 500° C. to 600° C. The catalytic oxidation of NO is performed preferably at 150° C. to 500° C. and more preferably 250° C. to 350° C.

More in detail, the preferred conditions for the removal of N2O include one or more of the following. A temperature of 400 to 700° C., more preferably 500 to 600° C.; a pressure of 1 to 20 bar abs; a space velocity in the catalyst of 3000 to 25000 h⁻¹, more preferably 5000 to 10000 h⁻¹.

The gas composition at the inlet of the N2O removal is preferably the following (% mol):
N2O 0.01 to 0.2
NO 1 to 10
O2 1 to 10
NO2 0.1 to 10
H2O 10 to 20.

Preferably the gas after the removal of N2O (effluent gas from stage where N2O is removed) has a NO2/NO ratio which is higher than that of the inlet gas. A related advantage is that the catalyst is operated in the optimal temperature range to achieve a high de-N2O activity without compromising the lifetime, entailing low N2O abatement cost and higher oxygen available for the NO oxidation step.

The removal of N2O at a temperature not greater than 700° C., preferably 400° C. to 700° C., has the advantage of a high abatement activity combined with a long life of the catalyst. In addition, a Fe-FER catalyst promotes the oxidation of NO to NO2 in this temperature range, so that a significant amount of NO is converted to NO2 also during the phase of removal of N2O (deN2O).

The reaction of oxidation from NO to NO2 is favored from equilibrium point of view at low temperature. In the cooling train in the nitric acid process, the equilibrium concentration of NO2 is very low at temperature higher than 700° C. and is substantially higher than 70% at 300° C. entailing low N2O abatement cost and higher oxygen available for the NO oxidation step.

The preferred conditions for the oxidation of NO into NO2 include one or more of: a temperature of 150 to 500° C., more preferably 250 to 350° C.; a pressure of 1 to 20 bar abs; a space velocity through the catalyst of 3000 to 25000 h⁻¹, more preferably 5000-10000 h⁻¹.

The range of 250 to 350° C. is most preferable range for the oxidation step because the extent of NO oxidation is maximized at the temperature at which the reaction heat is recovered as steam and not lost in cooling water.

The gas composition at the inlet of NO oxidation is preferably the following (%mol):
N2O up to 0.01,
NO up to 10;
O2 1 to 10,
NO2 1 to 10,
H2O 10 to 20.

Preferably the gas after the oxidation of NO has a NO2/NO ratio which is higher than that of the inlet gas of oxidation of NO. A related advantage is the optimal NO oxidation which is not limited by kinetic of the homogeneous gas phase reaction at temperature at which the catalyst is active. Another advantage is the heat of the oxidation is upgraded to steam generation because is recovered at higher temperature, which entails more energy efficiency. Still another advantage a higher level of oxidation is achieved at cooler condenser inlet which increases the weak acid condensation. In a dual pressure process the invention decreases the power of the NOx compressor which means increased plant efficiency and lower cost.

In a preferred embodiment, the NO2/NOx ratio at the outlet of the first catalyst may be 0.15 to 0.35, preferably 0.25 or about 0.25. The NO2/NOx ratio at the outlet of the second catalyst is greater and may be for example 0.6 to 0.8, preferably 0.7 or about 0.7.

Preferably the first catalyst and/or the second catalyst are fitted in one or more equipment selected between a vessel, a reactor, a heat exchanger or a pipe. Particularly preferably the first catalyst and/or the second catalyst are fitted in channels of a respective heat exchanger or in the pipe connecting two consecutive heat exchangers.

The first catalyst may be fitted in a first equipment and the second catalyst may be fitted in a second equipment, the second equipment being separate from the first equipment. For example the first equipment and the second equipment are hosted in separate pressure vessels. At least one heat exchanger may be arranged to cool the gas effluent from the first equipment before it reaches the second equipment, to obtain that the oxidation of NO is performed at a lower temperature than the removal of N2O.

The first catalyst and the second catalyst may also be fitted in the same reactor or same pressure vessel. In such embodiment the reactor or pressure vessel may include cooling means arranged to cool the gas after the passage through the first catalyst and before the passage through the second catalyst.

The catalyst flowed through by the gas, in the steps of N2O removal and NO oxidation, may form a catalytic bed or layer. Preferably the first catalyst and/or the second catalyst is/are in any of the following forms: extrudate or 3d printed or pelletized or shaped as structured catalyst, preferably washcoated or extruded monolith.

In a plant according to the invention a first catalytic bed or layer and a second catalytic bed or layer may be part of a cooling train arranged between the ammonia oxidation reactor and the absorber. Accordingly the removal of N2O and the oxidation of NO are performed in the cooling train of the plant, between the ammonia oxidation reactor and the absorber.

The first catalytic bed or layer and the second catalytic bed or layer may be hosted in the same pressure vessel or they may be arranged in two separate pressure vessels according to different embodiments.

A plant according to the invention may comprise at least one first heat exchanger arranged to cool the nitrous gas effluent of the ammonia oxidation reactor, before it enters the first catalytic bed or layer, and at least one second heat exchanger arranged to remove heat from the gas effluent from the first catalytic bed or layer, before it enters the second catalytic bed or layer. The first heat exchanger may include an evaporator and superheater; the second heat exchanger may include a tail gas heater.

The invention, in its various embodiments, can be applied to all processes and plants for the synthesis of nitric acid based on the Ostwald process, including the so-called dual-pressure process wherein the oxidation of ammonia and absorption are performed at different pressure.

Still another feature of the invention is the provision of a new waste heat boiler arranged to recover heat from the effluent gas of the second catalyst, after the oxidation of NO to NO2. The related advantage is a better heat recovery and additional production of steam.

Particularly it has to be emphasized that the catalytic abatement of N2O (deN2O reaction) over the first catalyst, in the presence of NO, leads to the formation of NO2 and hence increases the oxidation. In a particularly preferred embodiment the deN2O stage operates at 500° C. to 600° C. and a molar ratio NO2/NOx of 15% to 30% and a further oxidation is performed over the second catalyst at a lower temperature, typically 250° C. to 300° C. Typically the admitted to said further oxidation over the second catalyst has the following composition: 025%, H2O 16%, NOx 9%.

At the above conditions, a particularly advantageous optimization is reached, in terms of good oxidation, minimum amount (volume) of catalyst, good abatement of N2O, heat recovery and production of valuable steam.

### DESCRIPTION OF FIGURES

FIG. 1 is a scheme of a preferred embodiment of the invention.

FIG. 2 is a plot of a temperature and oxidation profile of a preferred embodiment of the invention.

### DETAILED DESCRIPTION

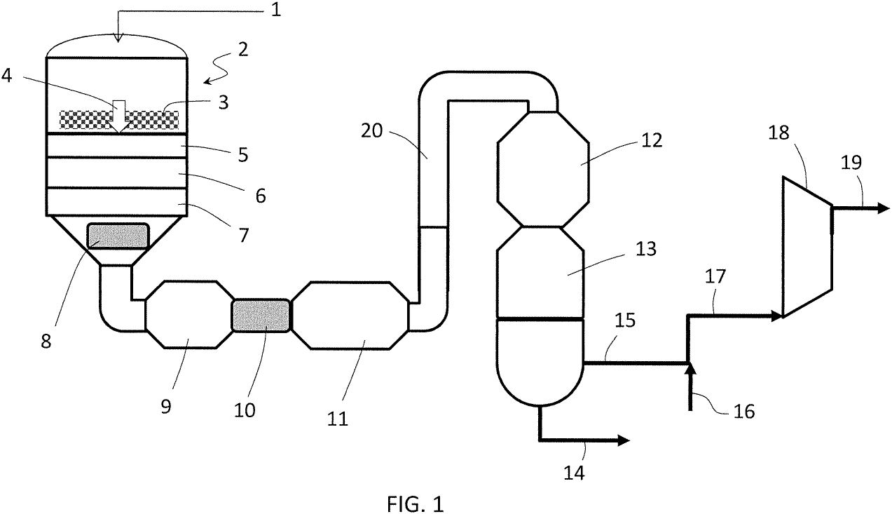

FIG. 1 discloses an example of the invention applied to a nitric acid dual pressure process. This term denotes a process where absorption is performed at a pressure greater than ammonia oxidation.

A mixture 1 of ammonia and air reacts in an ammonia oxidation reactor 2 over a suitable catalyst 3 to form a nitrous gas 4.

Ammonia oxidation with air is an exothermic reaction with the formation of NO (about 9% mol) and H2O (about 16%mol). Secondary reactions produce undesired components as N2 and N2O (typically about 1000 ppmv).

Hot nitrous gas 4 produced in ammonia oxidation reactor, is cooled up to about 500° C. passing through a superheater 6 and an evaporator 7. The item 5 denotes a support of the ammonia oxidation catalyst. The ammonia oxidation catalyst is possible to be supported on heat-resistant inert material in the form of beds, packings or honeycombs, which, viewed in the flow direction, have a depth of at least 5 cm, preferably at least 10 cm, in particular at least 20 cm and very particularly preferably from 20 to 50 cm. The inert material is contained in a basket and it is possible to cool the basket with a cooling medium.

A high-temperature de-N2O catalyst 8 is positioned between the evaporator 7 and a tail gas heater 8. Said catalyst 8 may be installed below the evaporator 7 and performs a N2O abatement, preferably to a residual N2O of not more than 20 ppm.

Particularly, when the nitrous gas passes through the catalyst 8 the N2O is decomposed into N2 and O2.

The passage through the catalyst 8 also increases the temperature due to NO oxidation up to about 530° C. The NO2/NOx ratio at the outlet of the catalyst 8 is about 0.25.

The nitrous gas leaving the catalyst 8, now with a reduced content of N2O, is cooled in the tail gas heater 9 and then passes through a low-temperature catalyst 10 where NO is oxidized to NO2.

The passage through the catalyst 10 increases the temperature up to about 370° C. and the NO2/NOx ratio to about 0.7.

This effluent gas from the low-temperature catalyst 10 traverses a waste heat boiler 11 and then goes via line 20 to an economizer 12 and a condenser 13.

The economizer 12 removes heat from the nitrous gas, decreasing the nitrous gas temperature close to dew point of the nitric acid. Nitric acid condensation is performed in the condenser 13 with cooling water.

Nitric acid condensed (weak acid) is recovered at line 14 and sent to an absorption tower. Nitrous gas 15 separated from weak acid is mixed with exhaust air 16 coming from a bleacher; the so obtained mixture 17 is sent to a nitrous gas compressor 18. In the nitrous gas compressor 18, the pressure is increased to about 12 bar abs and temperature rise up to 160° C. due to gas compression and further NO oxidation.

The delivery line 19 of the compressor 18 goes to an absorber where the gas is contacted with water for the production of nitric acid.

The high-temperature de-N2O catalyst 8 reduces the N2O concentration in nitrous gas to a proper level (N2O reduction preferably up to 98%), and boosts the NO oxidation. The low-temperature catalyst 10 performs NO oxidation reaction at about 300° C., increasing considerably the oxidation (NO2 / NOx ratio 0.7), and the temperature level up to about 370° C.

In the state of art, the temperature downstream the pipe at the outlet of the tail gas heater 9 is about 260° C., with a NO2/NOx ratio of about 0.6.

The higher temperature level reached downstream the low-temperature catalyst, allows to recover heat at higher temperature and produce more steam.

The low-temperature catalyst allows to reach higher level of NO2/NOx ratio at the inlet of the condenser 13 (about 80% compared to 73% in state of art), and that promotes the acid condensation. Since the weak acid 14 quantity produced in the process is higher (+3%) than state of art, nitrous gas at the inlet of nitric compressor is slightly lower and the required power decreases at the nitric compressor 18 (-1%). This leads to an additional power saving for the plant: the superheated steam generated is 2% higher than state of art, and the steam exported, considering steam turbine consumption and internal plant steam requirements, is 3% higher.

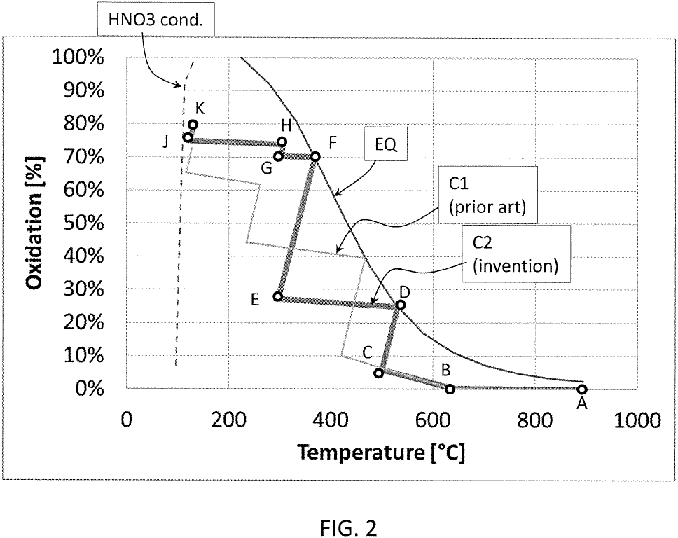

FIG. 2 illustrates a temperature and oxidation profile in a preferred embodiment of the invention.

The lines C1 and C2 show the oxidation level which is defined as NO2/NOx in molar base. The line C1 shows the oxidation level for the low pressure section in a typical nitric acid process of the prior art. The line C2 shows the oxidation level in an embodiment of the invention as illustrated in FIG. 1. Relevant points of the process are marked with letters A to K.

The line EQ represents the thermodynamic equilibrium for the oxidation reaction which sets an upper limit for the oxidation process, i.e. for the oxidation and temperature that can be reached in the process.

The dotted line “HNO3 cond” is the condition in which nitric acid condenses.

The oxidation NO+½ O2 ➔ NO2 is an exothermic reaction and the reaction heat causes the gas temperature to increase along the pipes.

The oxidation heat is recovered to obtain the maximum energy recovery without over-complicating the process and without the risk of working in corrosive areas.

It should be noted that: in heat exchangers, the temperature of the nitrous gas may decrease and the NO2/NOx ratio may increase due to the volume of the equipment. In pipeline connecting heat exchangers, oxidation and temperature increase due to NO oxidation. Oxidation in pipeline depends on volume of the pipes, so temperature and oxidation level is basically defined by plant layout.

The operating line C2 of the invention is now described.

Point A denotes the nitrous gas effluent from the ammonia oxidation catalyst at a temperature of about 900° C.

The segment A to B denotes cooling of the nitrous gas from 900° C. to a temperature slightly above 600° C. due to heat removed by the catalyst support 5 (e.g. internally cooled) and the superheater 6. At this high temperature range, no oxidation of NO occurs.

The segment B to C denotes the subsequent cooling in the evaporator 7 to about 500° C. At this temperature range oxidation of NO begins reaching about 5% at the outlet of the evaporator 7 (point C).

The segment C to D denotes the passage through the high-temperature deN2O catalyst 8. The high-temperature catalyst 8 reduces the N2O concentration in nitrous gas to a proper level, preferably N2O reduction up to 98%, and boosts the NO oxidation, reaching the thermodynamic value. It can be appreciated that point D lies practically on the equilibrium curve EQ.

The segment D to E denotes cooling of the nitrous gas through the tail gas heater 9.

The segment E to F denotes the strong oxidation of NO through the low-temperature catalyst 10. Said catalyst 10 performs NO oxidation reaction at about 300° C., increasing considerably the oxidation NO2/NOx ratio up to 0.7 and the temperature level up to about 370° C.

The subsequent segment F to G denotes cooling in the waste heat boiler 11. The segment G to H denotes a slight heating and oxidation occurring through the pipe 20. The segment H to J denotes cooling in the economizer 12 and the segment J to K relates to the piping from the economizer 12 to the condenser 13. The oxidation ratio at the inlet of the condenser (point K) is about 80%.

The curve C1 denotes a prior art process wherein the nitrous gas starting from the same point A at 900° C. is cooled up to about 420° C. in a superheater and evaporator; the nitrous gas coming out from the evaporator flows through the bottom of the ammonia oxidation reactor and a line connecting to a tail has heater, increasing the NO2/NOx ratio to about 0.4 and the temperature to about 460° C.; in a pipe connecting the tail gas heater to the economizer the NO2/NOx ratio further increases to about 0.6 and the temperature rises to about 260° C. An economizer recovers heat from nitrous gas decreasing the nitrous gas temperature close to the nitric acid dew point. At the end of the curve C1 (inlet of nitric acid condenser) the oxidation ratio is about 73%.

The advantages of the invention can be appreciated by comparing the curve C2 of the invention with the curve C1 of the prior art.

It can be seen that the curve C2 of the invention better approaches the ideal curve EQ, which is reached at points D and F. The final oxidation reached by the invention at the inlet of the condenser 13 is around 80% at point K, compared with 73% reached by the reference prior art. This higher ratio promotes the acid condensation.

Particularly, the invention reaches a higher temperature and oxidation thanks to the low-temperature oxidation catalyst. The reference prior art, in absence of such catalyst, reaches a temperature of about 260° C. and a NO2/NOx ratio of about 0.6 in the connecting pipe between the tail gas heater and the economizer. The higher temperature reached by the invention allows to recover heat at higher temperature and produce more steam.

1-25. (canceled)

26. A process for producing nitric acid, the process comprising:
a) catalytic oxidation of ammonia in the presence of oxygen to form a nitrous gas containing NO, O₂, N₂O, and water vapor;
b) processing said nitrous gas to reduce a content of N₂O in said nitrous gas and convert NO into NO₂;
c) using the processed nitrous gas, obtained from step b), in an absorption step wherein NO₂ is absorbed in water to produce nitric acid,
wherein step b) includes:
b1) a catalytic abatement of N₂O that is performed by passing the nitrous gas over a first catalyst, at a temperature that is lower than a temperature of the catalytic ammonia oxidation at step a),
b2) a catalytic conversion of NO into NO₂ that is performed after the step b1), passing the nitrous gas over a second catalyst.

27. The process according to claim 26 wherein said first catalyst includes a transition metal-oxide or aluminum silicate.

28. The process according to claim 27 wherein said first catalyst includes an iron loaded ferrierite (Fe-FER) or a ferrierite that is not loaded with iron (FER).

29. The process according to claim 26 wherein said second catalyst includes a transition metal-oxide or an aluminum silicate.

30. The process according to claim 26 wherein said second catalyst includes iron loaded ferrierite (Fe-FER) or ferrierite that is not loaded with iron (FER).

31. The process according to claim 26 wherein each of the first catalyst and the second catalyst includes iron-loaded ferrierite (Fe-FER), the ferrierite of the first catalyst having a higher concentration of iron than the ferrierite of the second catalyst.

32. The process according to claim 26 wherein the step b1) is performed after at least one step of cooling the gas effluent from step a), and wherein the step b1) is performed at a temperature not greater than 700° C.

33. The process according to claim 26, wherein the step b1) is performed at a higher temperature than the step b2), the nitrous gas being cooled in at least one heat exchanger after step b1) and before step b2).

34. The process according to claim 33 wherein the catalytic abatement of N₂O of step b1) is performed at 400° C. to 700° C., and the catalytic oxidation of NO of step b2) is performed at 150° C. to 500° C.

35. The process according to claim 26 wherein the first catalyst and/or the second catalyst are fitted in one or more equipment selected from a vessel, a reactor, a heat exchanger, or a pipe.

36. The process according to claim 35 wherein the first catalyst and/or the second catalyst are fitted in channels of a respective heat exchanger and/or in the pipe connecting two consecutive heat exchangers.

37. The process according to claim 26 wherein the first catalyst is fitted in a first equipment and the second catalyst is fitted in a second equipment, separate from the first equipment, and at least one heat exchanger is arranged to cool the gas effluent from the first equipment before it reaches the second equipment.

38. The process according to claim 26, wherein the first catalyst and the second catalyst are fitted in the same reactor or same pressure vessel and the reactor or pressure vessel includes cooling means arranged to cool the gas between the first catalyst and the second catalyst.

39. The process according to claim 26 wherein the first catalyst and/or the second catalyst is/are in any of the following forms: extrudate or 3D printed or pelletized or shaped as structured catalyst.

40. The process according to claim 26 wherein steps b1) and b2) are performed in a cooling train arranged to cool the nitrous gas effluent from the ammonia oxidation reactor and before it enters the absorber.

41. The process according to claim 26 wherein the second catalyst used in step b2) for the oxidation of NO contains iron-loaded ferrierite (Fe-FER) and is an aged catalyst previously used in the step b1) for decomposition of N2O.

42. The process according to claim 41, further comprising:
using a Fe-FER catalyst in step b1) for the decomposition of N₂O and for a predetermined service life; and
after the above service life is completed, using aged catalyst taken from said step b1) in the step b2) as a catalyst for the oxidation of NO to NO₂.

43. A plant for producing nitric acid, the plant comprising:
an ammonia oxidation reactor configured for catalytic oxidation of ammonia in the presence of oxygen to form a nitrous gas containing NO, O₂, N₂O, and water vapor;
an absorber where a NO₂-containing gas is subjected to absorption in water to produce nitric acid;
at least a gas cooler;
a first bed or layer of a first catalyst for decomposition of N₂O; and
a second bed or layer of a second catalyst for oxidation of NO to NO₂ that are arranged, in this order, between the ammonia oxidation reactor and the absorber, so that a nitrous gas produced in the oxidation reactor passes through the gas cooler, the first catalyst and then through the second catalyst before the nitrous gas enters the absorber.

44. The plant according to claim 43 wherein the first catalyst and/or the second catalyst includes a transition metal-oxide or aluminum silicate.

45. The plant according to claim 43 wherein the first catalytic bed or layer and a second catalytic bed or layer are part of a cooling train arranged between the ammonia oxidation reactor and the absorber.

46. The plant according to claim 43 wherein the first catalytic bed or layer and the second catalytic bed or layer are arranged in the same pressure vessel or arranged in two separate pressure vessels.

47. The plant according to claim 43, further comprising one or more of: a first heat exchanger arranged to cool the nitrous gas obtained from the oxidation of ammonia, before the nitrous gas enters the first catalytic bed or layer; a second heat exchanger arranged to remove heat from the gas effluent from the first catalytic bed or layer, before the gas effluent enters the second catalytic bed or layer; or a waste heat boiler arranged to recover heat from the effluent gas of the second catalyst, after the oxidation of NO to NO₂.

48. The plant according to claim 43, wherein said first catalyst and second catalyst two catalysts are fitted in devices as vessel, reactors, heat exchanger.

49. A process for producing nitric acid, the process comprising:
catalytic oxidation of ammonia in the presence of oxygen to form a nitrous gas containing NO, O2, N₂O and water vapor;
processing the so obtained nitrous gas and using the so obtained processed nitrous gas to produce nitric acid by absorption of NO₂ in water;
wherein the processing of nitrous gas comprises a step of oxidation of NO to NO₂ that is performed over a Fe-FER catalyst.

50. In a process of production of nitric acid, using of aged Fe-FER catalyst, previously used for decomposition of N₂O in a gas containing nitrogen, oxygen, N₂O, NOx and water, as a catalyst for oxidation of NO to NO₂, to increase the content of NO₂ in a nitrous gas before contacting the gas with water for absorption of NO₂ in water and production of nitric acid.
